(19) United States
(12) Patent Application Publication
(10) Pub. No.: US 2012/0194413 A1
(43) Pub. Date: Aug. 2, 2012

(54) DISPLAY DEVICE

(75) Inventors: Kohji Yabuta, Osaka (JP); Mikihiro Noma, Osaka (JP); Takao Takada, Osaka (JP)

(73) Assignee: SHARP KABUSHIKI KAISHA, Osaka (JP)

(21) Appl. No.: 13/500,240

(22) PCT Filed: May 12, 2010
(86) PCT No.: PCT/JP2010/058022

§ 371 Date: Apr. 4, 2012

(30) Foreign Application Priority Data
Oct. 5, 2009 (JP) 2009-231567

(51) Int. Cl. G09G 3/36

(52) U.S. Cl. 345/87

(57) ABSTRACT

Disclosed is a display device in which deterioration in resolution may be suppressed when an image is being read, by reducing the diffusion of reflected light from a printed material, and in which a wide viewing angle may be achieved when an image is being displayed. The display device is provided with a display panel for reading and displaying image data. The display panel has a plurality of pixels provided with light receiving elements. A plate-shaped lens member is arranged on the display surface side of the display panel. A transparent section formed of material having a high refractive index and a colored section formed of material having a low refractive index are arranged alternately in the lens member when seen in plan view. In the cross section in the thickness direction, the transparent section has a trapezoidal shape which is wider on the display panel side, and the colored section has a shape which is narrower on the display panel side.

### TECHNICAL FIELD

The present invention relates to a display device. More specifically, the present invention relates to a display device equipped with a reading function of image data.

### BACKGROUND ART

As a display device equipped with a display panel for displaying images, various display devices such as liquid crystal display devices, organic electroluminescence (hereinafter also referred to as “EL”) display devices, and inorganic EL display devices are known to the public. Liquid crystal display devices especially have been widely used in electronic devices such as monitors, projectors, mobile phones, and personal digital assistants (PDA) by taking advantages of the fact that liquid crystal display devices are thin, lightweight, and have low power consumption. In recent years, along with the widespread use of mobile devices such as smartphones and PDAs (Personal Digital Assistants), it has been desired to develop a liquid crystal display device that can not only display images, but also has an image reading function (hereinafter also referred to as a scanner function) in which information printed on a sheet of paper or the like can be scanned into the device as electronic information.

As a device equipped with the scanner function, it has been suggested devices such as a device described in Patent Document 1 that has a configuration in which an optical fiber array is arranged so as to penetrate through a transparent substrate in the thickness direction, light receiving elements are mounted so as to have contact with an end face of the fiber array, and optical information from a manuscript surface illuminated by a light source is guided to the light receiving elements through the fiber array on a one-by-one basis. However, such a device only includes the scanner function for reading image data, and the read image data is displayed on a monitor provided separately. Accordingly, the size of the entire device increases, it is not suitable for use in the above-mentioned mobile devices.

In view of this, in order to add the scanner function to a liquid crystal display panel for displaying image data itself, use of a liquid crystal display panel in which each pixel thereof is provided with a built-in light receiving element (optical sensor element) has been suggested. The light receiving element is provided at each of the pixels in a thin film transistor (TFT) array substrate along with TFT elements for driving liquid crystal, for example.

A liquid crystal display device equipped with the light receiving elements performs image display in a manner similar to a normal liquid crystal display device, and performs reading of image data in the following manner. First, an object such as a printed material with image data is placed on a display surface side of the liquid crystal display panel. Then, when light is emitted from a light source of the liquid crystal display panel onto the object, this light is reflected by a surface of the object while having reflective intensity information in accordance with the printed pattern (such as letters and figures), and therefore, by using light receiving elements to detect the light reflected by the object, the image data can be read. The read image data can be displayed on a liquid crystal display panel in a manner similar to other images.

In this way, a liquid crystal display device capable of displaying images while having the scanner function can display images and read image data using the same screen, and therefore, it is suited for use in the above-mentioned mobile devices because a smaller and thinner device can be achieved.

### RELATED ART DOCUMENTS

### Patent Documents

Patent Document 1: Japanese Patent Application Laid-Open Publication H2-105774

### SUMMARY OF THE INVENTION

### Problems to be Solved by the Invention

However, when the read image data is displayed on the liquid crystal display device having the above-mentioned configuration, the image sometimes becomes blurred due to deterioration in resolution. Deterioration in resolution becomes prominent when a distance between light receiving elements and an object becomes large, and therefore, it is preferable that the distance be as small as possible, however, there is a limit to how close the distance can be between the light receiving elements and the object because there are an opposite substrate, a polarizing plate and the like, which configure the liquid crystal display panel, existing between the TFT array substrate including light receiving elements and the printed material.

The above-mentioned deterioration in resolution is considered to be caused by the fact that when image data is being read, light emitted from the light source is diffusely-reflected by the surface of the object, and a wide range of the reflected light are mixed together to enter the light receiving elements.

Furthermore, a protective plate for protecting a liquid crystal display panel from dust and impacts may be disposed on a display surface side of the liquid crystal display panel. When such a protective plate is provided, the resolution of images becomes 10 ppi or lower regardless of the density of the light receiving elements.

A member having a light shielding function (louver function) for reducing diffusion of the reflected light may be considered to be provided on the display screen side of the liquid crystal display panel in order to suppress such deterioration in resolution, however, arranging such a member on the display screen side of the liquid crystal display panel may result in deterioration in viewing angle characteristics when an image is being displayed.

The present invention was devised in view of the above-mentioned current situation, and an object of the present invention is to provide a display device in which diffusion of light reflected by a printed material is reduced so that deterioration in resolution can be suppressed when an image is being read, and in which a wide viewing angle can be realized when an image is being displayed.

### Means for Solving the Problems

The present inventors have studied various display devices equipped with a liquid crystal display panel having an image reading function, and first focused on the following fact. That is, deterioration in resolution occurs when an image data is read because light from the display panel side is reflected by a surface of a printed material to generate reflected light; this reflected light is then diffused and enters the display panel again; and because the resulting light is received by light receiving elements provided in the display panel. Then, the inventors have found that when a lens member having both light-shielding characteristics and transparency is provided between the display panel and the printed material, due to the light-shielding characteristics (louver function) and the lens function of this lens member, diffusion of light reflected by the printed material can be reduced and deterioration in resolution can be suppressed. Moreover, the inventors have also found that a wide viewing-angle can be realized when an image is being displayed because of the lens function of the above-mentioned lens member, and have come to realization that the above-mentioned problem can be solved, thereby arriving at the present invention.

That is, the present invention is a display device equipped with a display panel for reading and displaying an image data, wherein the display panel includes a plurality of pixels having light receiving elements, wherein a plate-shaped lens member is arranged on a display surface side of the display panel, and wherein the lens member has a configuration in which a transparent section made of a material with high refractive index and a colored section made of a material with low refractive index are arranged alternatively when viewed in a plan view, and in a cross-section in thickness direction, the transparent section has a trapezoidal shape that is wider on a display panel side, and the colored section has a shape that is narrower on the display panel side.

A display device of the present invention can read and display an image data using the same display panel, and therefore, a smaller and thinner device can be realized.

A display device of the present invention has a configuration in which a plate-shaped lens member is disposed on a display surface side of the display panel. When an image data is to be read, an object such as a printed material is placed on the lens member, and then the display panel is activated. This way, light is emitted from the display panel onto the object, and the emitted light is reflected by a surface of the object while having reflective intensity information in accordance with the printed pattern (such as letters and figures). The reflected light is received by the light receiving elements through the lens member, and this enables reading of the image data. When an image is to be displayed, the image is displayed on the display panel in a manner similar to a normal liquid crystal display device.

It is preferable that the lens member and a printed material be placed as close as possible when an image data is being read. This is because when a distance between the lens member and the printed material becomes large and a gas layer (air layer) exists therebetween, light reflected by the printed material becomes mixed together before entering the lens member, causing reduction in light collecting effects by the above-mentioned louver function and the lens function, and as a result, sufficient effect of suppressing deterioration in resolution may not be achieved.

When the above-mentioned display panel is a liquid crystal display panel that is used in a liquid crystal display device, for example, it has a configuration in which a liquid crystal layer is interposed between a pair of substrates, and each of a plurality of pixels is provided with a light receiving element. The pair of substrates commonly includes a thin film transistor (TFT) array substrate and a color filter (CF) substrate, and a light receiving element is formed in each of the pixels in the TFT array substrate along with a TFT element for driving the liquid crystal, for example. Photodiodes may be used as the above-mentioned light receiving elements, for example.

The above-mentioned lens member is a plate-shaped member, and has transparent sections made of a material with high refractive index and colored sections made of a material with low refractive index. The transparent sections and the colored sections are arranged alternatively when viewed in a plan view, and the colored sections have the louver function, which is a function to block a part of light. When an image is to be read, a part of light that has been reflected and diffused at a surface of a printed material or the like is blocked by the louver function.

Furthermore, in the above-mentioned lens member, the transparent sections with high light refractive index are placed between the colored sections with low light refractive index when seen in a cross-section in the thickness direction, and the shape of the transparent sections is a trapezoidal shape that is wider on the display panel side, and therefore, the lens member demonstrates the lens function for collecting the remaining reflected light that has not been blocked by the louver function at the transparent sections and guiding it to the light receiving elements. This lens function makes it possible to reduce reflected light from a printed material or the like from being mixed together to enter the light receiving elements, thereby suppressing unnecessary information that enters the light receiving elements. This way, when a read image is displayed on the display panel, deterioration in resolution of the read image can be suppressed.

As long as the configuration of a display device according to the present invention includes such components as the mandatory elements, it is not specially limited by other components.

The display device may further include a protective member between the display panel and the lens member. As the protective member, a protective plate that is used to protect a display surface of the display panel from impacts and dust from outside may be used.

The above-mentioned protective plate is usually made of a transparent material, and a resin plate made of acrylic resin, polycarbonate resin or the like, or a glass substrate or the like can be used, for example. Further, the protective plate may either be colorless or colored. When the protective plate is colorless, the display device can display an image with exactly the same color tone as the displayed image on the display panel, and on the other hand, when the protective plate is colored, the display device can display an image displayed on the display panel as an image that has been changed to a blue tone, a red tone or the like, for example. The thickness of the above-mentioned protective plate is not specially limited, but it is preferable that the thickness be as small as possible in consideration of when image data is being read, and may be approximately 0.8 mm to 1.2 mm, for example.

The display device may further include an air layer between the display panel and the lens member. When the protective plate is provided as described above, an air layer may exist between the protective plate and the liquid crystal display panel, and/or between the protective plate and the lens member. The thickness of the air layer is not specially limited, but it is preferable that the thickness be as small as possible in consideration of when image data is being read, and may be approximately 0.5 mm to 0.8 mm, for example. Even such an air layer is included, the present invention can still reduce reflected light from a printed material or the like because of the louver function and the lens function of the lens member, and therefore, light path of the collected light is not blocked by the air layer, and deterioration in resolution of the read image can be suppressed.

Moreover, in a liquid crystal display device according to the present invention, the lens member may be detachably installed on the display panel, and may have a configuration in which the lens member is attached to the display panel when an image is to be read. When the lens member is attached, it may either be fixed to or just placed on the display panel. Such a configuration makes it possible to reduce reflected light from a printed material or the like when an image is read as described above, and to display as a normal display panel when an image is displayed.

The protective member may be a glass fiber array including a plurality of glass fibers arranged perpendicularly to a panel surface of the display panel. In a display device having such a configuration, light reflected by a printed material or the like still transmits through the glass fiber array perpendicularly to the panel surface, and therefore, deterioration in resolution of the read image can be suppressed in a manner similar to the above-mentioned configurations.

The display device may be a liquid crystal display device, and may further include a light source on a side of the display panel that is opposite to a side on which the lens member is disposed. A backlight or the like may be used as the light source.

Each of the above-described embodiments may be combined as appropriate without departing from the scope of the present invention.

### Effects of the Invention

According to a display device of the present invention, by providing a lens member having light-shielding characteristics on the side of an image data reading surface of the display panel, it is possible to reduce the diffusion of reflected light from a printed material when an image is read so that deterioration in resolution of the read image can be suppressed, and to achieve a wide viewing angle when an image is displayed.

### BRIEF DESCRIPTION OF THE DRAWINGS

FIG. 1 is a schematic longitudinal cross-sectional view showing a configuration of a liquid crystal display device according to Embodiment 1.

FIG. 2 is a schematic cross-sectional view showing a configuration of a lens member according to Embodiment 1.

FIG. 3 is a schematic perspective view showing a configuration of a lens member according to Embodiment 1.

FIG. 4 is a schematic plan view showing a configuration of a lens member according to Embodiment 1.

FIG. 5 is a schematic cross-sectional view showing a configuration of another lens member according to Embodiment 1.

FIG. 6 is a schematic perspective view showing a configuration of another lens member according to Embodiment 1.

FIG. 7 is a schematic plan view showing a configuration of another lens member according to Embodiment 1.

FIG. 8 is a schematic cross-sectional view showing a configuration of another lens member according to Embodiment 1.

FIG. 9 is a schematic perspective view showing a configuration of another lens member according to Embodiment 1.

FIG. 10 is a schematic plan view showing a configuration of another lens member according to Embodiment 1.

FIG. 11 is a schematic longitudinal cross-sectional view showing a configuration of a liquid crystal display device according to Embodiment 1 when an image data is being read.

FIG. 12 is a plan view showing an example of a read image displayed on a liquid crystal display device according to Embodiment 1.

FIG. 13 is a schematic longitudinal cross-sectional view showing a configuration of a liquid crystal display device according to Embodiment 1 when an image data is being displayed.

FIG. 14 is a schematic longitudinal cross-sectional view showing a configuration of another example of a liquid crystal display device according to Embodiment 1 when an image is being read.

FIG. 15 is a schematic longitudinal cross-sectional view showing a configuration of another example of a liquid crystal display device according to Embodiment 1 when an image is being displayed.

FIG. 16 is a schematic longitudinal cross-sectional view showing a configuration of another example of a liquid crystal display device according to Embodiment 1 when an image is being read.

FIG. 17 is a schematic longitudinal cross-sectional view showing a configuration of another example of a liquid crystal display device according to Embodiment 1 when an image is being displayed.

FIG. 18 is a schematic longitudinal cross-sectional view showing a configuration of a liquid crystal display device according to Embodiment 2.

FIG. 19 is a schematic cross-sectional view showing a configuration of a liquid crystal display device according to Embodiment 2 when scanning.

FIG. 20 is a schematic cross-sectional view showing a configuration of a liquid crystal display device according to Embodiment 2 when an image is being displayed.

FIG. 21 is a schematic longitudinal cross-sectional view showing a configuration of a liquid crystal display device according to Embodiment 3.

FIG. 22 is a schematic longitudinal cross-sectional view showing a liquid crystal display device according to Embodiment 3 when scanning.

FIG. 23 is a schematic longitudinal cross-sectional view showing a liquid crystal display device according to Embodiment 3 when an image is being displayed.

FIG. 24 is a schematic longitudinal cross-sectional view showing a configuration of a liquid crystal display device according to Comparison Example 1 when scanning.

FIG. 25 is a schematic longitudinal cross-sectional view showing a configuration of a liquid crystal display device according to Comparison Example 1 when an image is being displayed.

FIG. 26 is a schematic longitudinal cross-sectional view showing a liquid crystal display device according to Comparison Example 2 when scanning.

FIG. 27 is a plan view showing a displayed image obtained in a liquid crystal display device according to Comparison Example 2.

### DETAILED DESCRIPTION OF EMBODIMENTS

The present invention will be further explained in detail by introducing embodiments with reference to the figures below, but the present invention is not limited to these embodiments only. In each of the embodiments and comparison examples described below, the same reference characters are used for similar components, and the description of them will be omitted.

### Embodiment 1

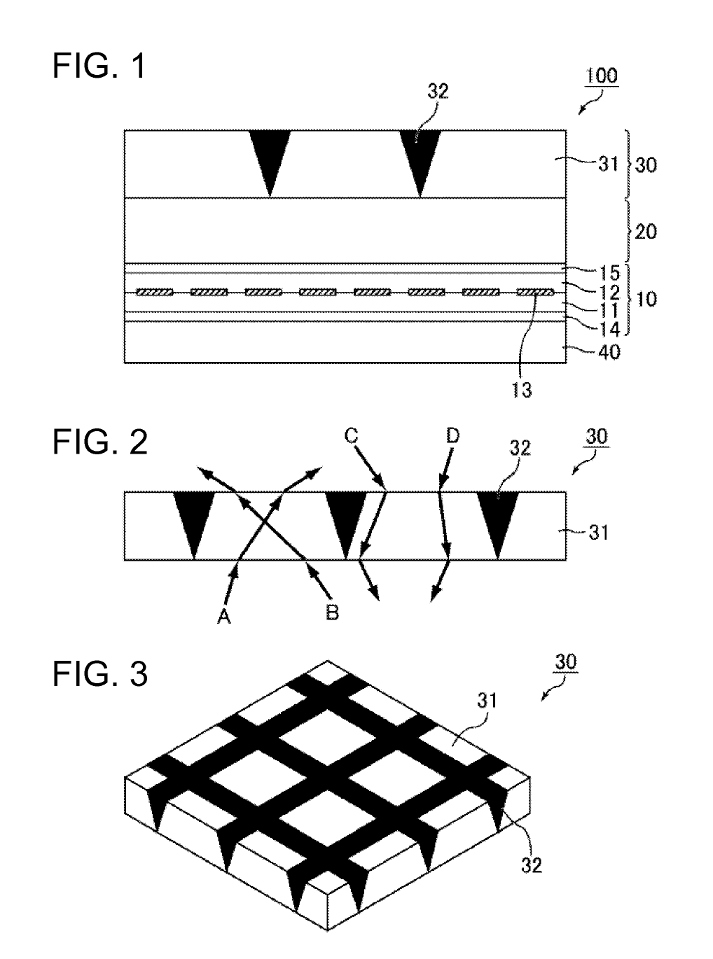

In the present embodiment, a liquid crystal display device provided with a protective plate between a liquid crystal display panel and a lens member will be described. FIG. 1 is a schematic longitudinal cross-sectional view showing the configuration of a liquid crystal display device according to the present embodiment, and FIGS. 2 to 4 are schematic views showing the configuration of a lens member. In FIG. 1, a liquid crystal display device 100 includes a liquid crystal display panel 10, a protective plate 20, a lens member 30, and a backlight 40 that is a light source.

The liquid crystal display panel 10 includes a pair of substrates 11 and 12 that are disposed facing each other, and a liquid crystal layer is interposed between the two substrates although not shown in the figure. Specifically, the substrate 11 is a thin film transistor (TFT) array substrate, and the substrate 12 is a color filter (CF) substrate. On a principal surface of the substrate 11, a plurality of pixels are arranged in a matrix, and each of the pixels is provided with a TFT and a light receiving element 13. The light receiving elements 13 are photo diodes, for example. The substrates 11 and 12 are respectively provided with polarizing plates 14 and 15 on the surfaces opposite to the sides where the liquid crystal layer is provided.

The liquid crystal display panel 10 is a transmissive liquid crystal display panel, and the backlight 40 is disposed on the side opposite to the display surface.

The polarizing plates 14 and 15 are not specially limited, and it is possible to use a polyvinyl alcohol (PVA) film to which an anisotropic material such as an iodine complex having dichroism has been absorbed/oriented or the like, for example.

The protective plate 20 is a member for protecting a display surface of the liquid crystal display panel 10. The protective plate 20 may be attached to the entire surface of the liquid crystal display panel 10 by a transparent adhesive agent or the like, but it may also be attached by a sealing agent or the like that is applied to an outer rim of the display region of the liquid crystal display panel 10. A resin plate made of acrylic resin, polycarbonate resin or the like, or a glass substrate or the like may be used as a material forming the protective plate 20.

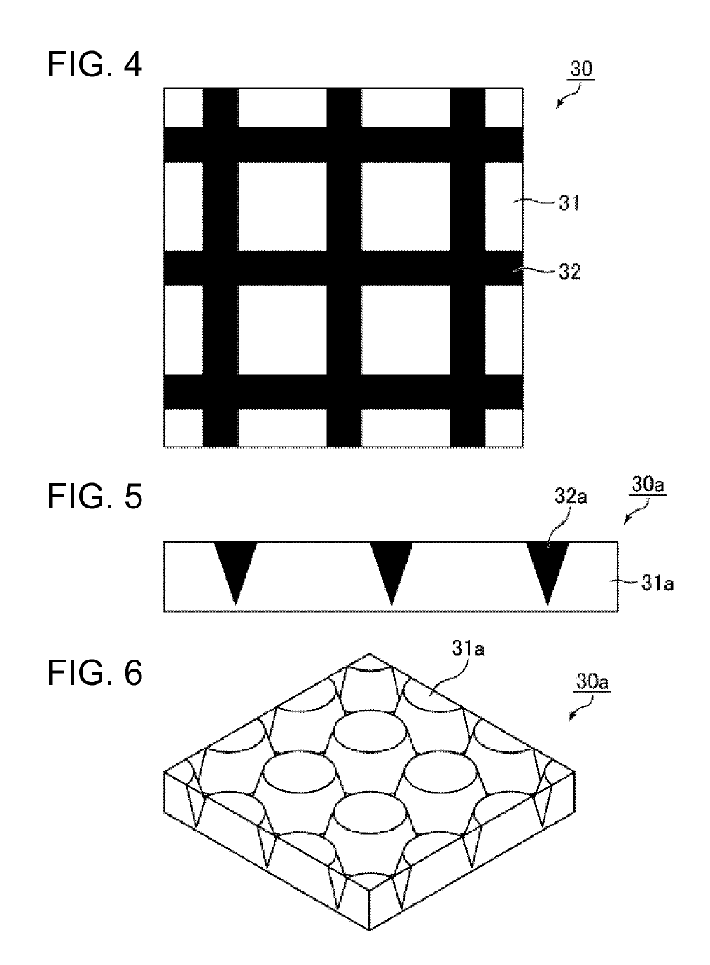

The lens member 30 is disposed on the display surface side of the liquid crystal display panel 10, and has the lens function for collecting light reflected by a printed material and the louver function for reducing the diffusion of the reflected light. FIGS. 2 to 4 are schematic views showing the configuration of the lens member 30, and FIG. 2 shows a cross-sectional view of the lens member, FIG. 3 shows a perspective view of the lens member, and FIG. 4 shows a plan view of the lens member, respectively.

As shown in FIG. 2, the lens member 30 includes a transparent section 31 having a trapezoidal shape that is wider on the liquid crystal display panel 10 side when viewed in a cross-section of the thickness direction, and this shape enables the lens function. A colored section 32 has a shape that is narrower on the liquid crystal display panel 10 side (wedge shape), and demonstrates the louver function for blocking unnecessary reflected light. Here, the colored section 32 has a triangle shape having a vertex thereof facing the liquid crystal display panel 10 side, but it may also be in a trapezoidal shape.

Further, as shown in FIG. 3, the lens member 30 has a configuration in which columnar bodies having a trapezoidal shape in the cross-section in the thickness direction are arranged between the belt-shaped colored sections 32 that are arranged in a grid pattern, and as shown in FIG. 4, the transparent sections 31 with high light refractive index and the colored sections 32 with low light refractive index are arranged alternatively when seen in plan view.

The refractive index of the transparent sections 31 is not specially limited as long as it is higher than the refractive index of the colored sections 32, but the refractive index may be approximately 1.5 to 1.6 in consideration of the lens function, for example. A color used for the colored sections 32 is not specially limited as long as the colored sections 32 are colored such that they can demonstrate the light-shielding characteristics (louver function) capable of reducing the diffusion of light reflected by a printed material, but black is preferable. Such a configuration can be achieved by using a resin material including black pigment, black dye, or the like to form the colored sections 32. Furthermore, the refractive index of the colored sections 32 is not specially limited as long as it is lower than the refractive index of the transparent sections 31, but it may be approximately 1.4 to 1.5, for example. An example of the refractive index of the transparent sections 31 and the colored sections 32 is that 1.56 for the refractive index of the transparent sections 31 and 1.48 for the refractive index of the colored sections 32.

In the lens member 30 having the above-mentioned configuration, as shown in FIG. 2, light incident from the side of the liquid crystal display panel 10 passes through the transparent section 31 and is emitted toward the display surface side as shown by the arrows A and B. When an image is being read, light reflected by a printed material or the like passes through the transparent section 31 and is collected in the vertical direction, and light in oblique directions is blocked by the colored sections 32 and is emitted toward the side of the liquid crystal display panel 10 as shown by the arrows C and D. This makes it possible to prevent reflected light from being mixed together.

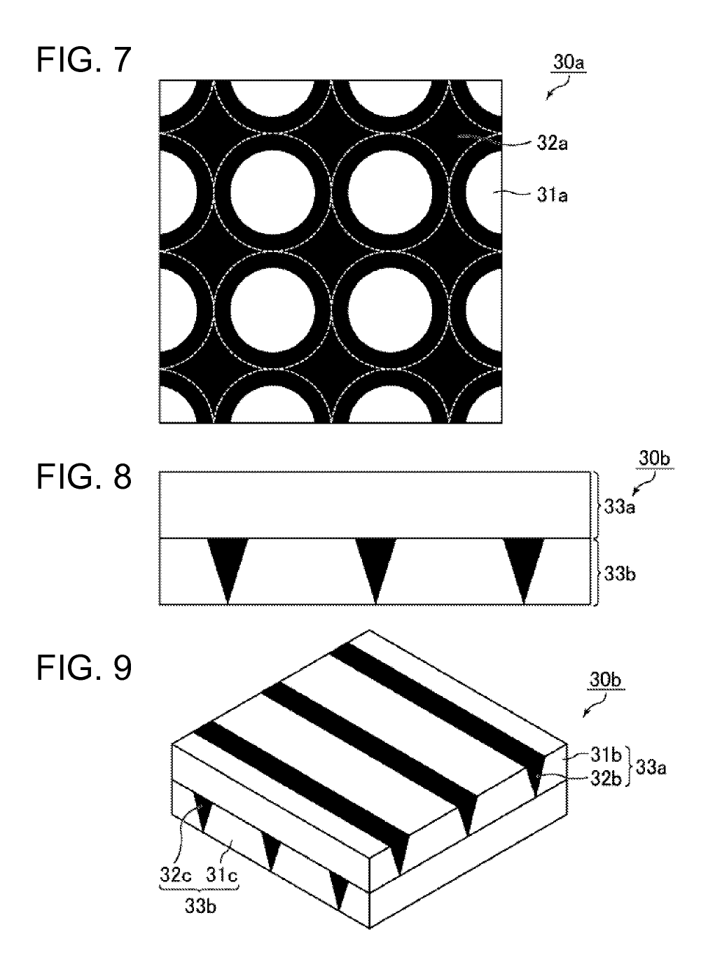

The lens member 30 is not limited to the lens member having the transparent sections 31 arranged in a grid pattern as shown in FIGS. 2 to 4, and a lens member such as a lens member 30a shown in FIGS. 5 to 7 and a lens member 30b shown in FIGS. 8 to 10 can be used, for example. FIGS. 5 to 7 are schematic views showing the configuration of the lens member 30a, and FIG. 5 shows a cross-sectional view of the lens member, FIG. 6 shows a cross-sectional perspective view of the lens member, and FIG. 7 shows a plan view of the lens member, respectively. Here, the colored sections are not indicated in FIG. 6.

As shown in FIGS. 5 to 7, in the lens member 30a, columnar transparent sections 31a are arranged so as to correspond to the respective pixels. Colored sections 32a are formed so as to fill the gap between adjacent transparent sections 31a. The lens member 30a with such a configuration also has the lens function and the louver function in a manner similar to the above-mentioned lens member.

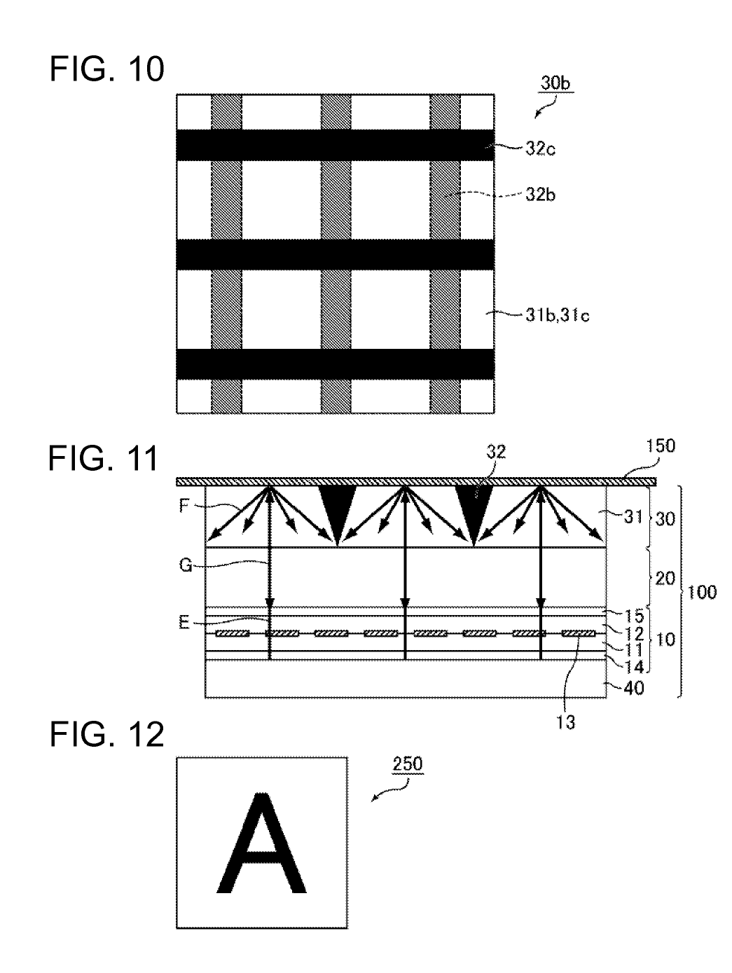

Moreover, FIGS. 8 to 10 are schematic views showing the configuration of the lens member 30b , and FIG. 8 shows a cross-sectional view of the lens member, FIG. 9 shows a perspective view of the lens member, and FIG. 10 shows a plan view of the lens member, respectively. The lens member 30b includes a first lens member 33a in which belt-shaped transparent sections 31b and belt-shaped colored sections 32b are arranged alternatively, and a second lens member 33b in which belt-shaped transparent sections 31c and belt-shaped colored sections 32c are arranged alternatively. The first lens member 33a and the second lens member 33b are arranged such that the colored sections 32b and the colored sections 32c intersect with each other. The transparent sections 31b and 31c are formed so as to correspond to the alignment of the pixels. The lens member 30b with such a configuration also has the lens function and the louver function.

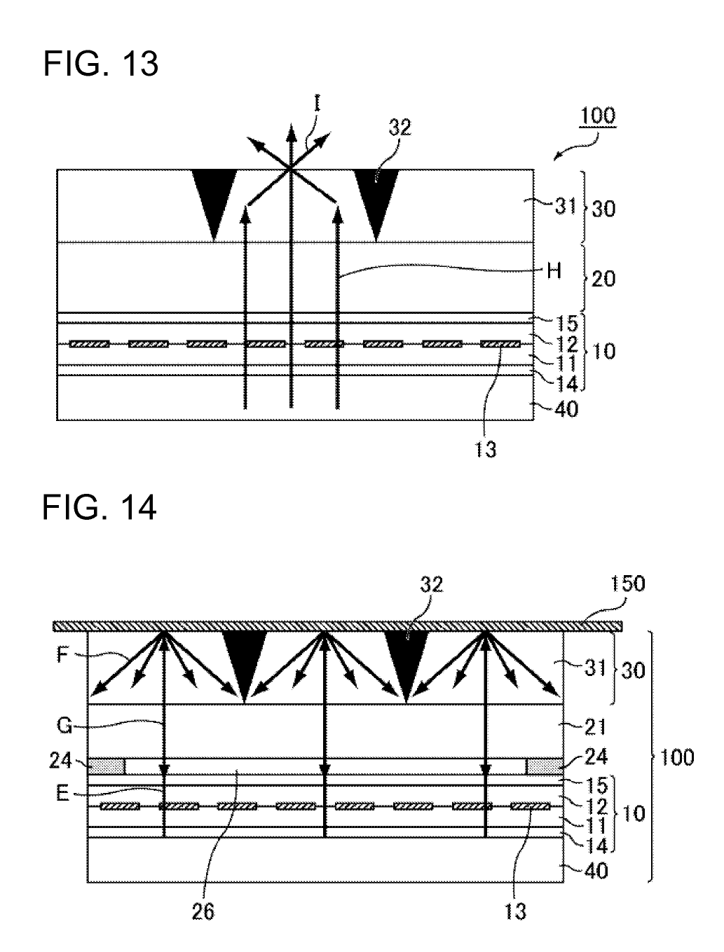

The liquid crystal display device 100 in the above-mentioned configurations can read and display image data. The detail will be explained with reference to FIGS. 11 to 13. FIG. 11 is a schematic longitudinal cross-sectional view showing a configuration when an image data is read (hereinafter also referred to as when scanning), FIG. 12 is a plan view showing an example of a read image, and FIG. 13 is a schematic longitudinal cross-sectional view showing a configuration when an image data is displayed (hereinafter also referred to as when an image is being displayed).

As shown in FIG. 11, the lens member 30 is placed directly on or closely to a printed material 150 when scanning. It is preferable that a distance between the lens member 30 and the printed material 150 be as small as possible because the diffusion of light reflected by the printed material or the like can be suppressed.

When the liquid crystal display device 100 is activated, light from the backlight 40 as shown by the arrows E passes through the liquid crystal display panel 10, the protective plate 20, and the lens member 30, and illuminates an object to be scanned, that is, the printed material 150 in this case. This light is reflected by a surface of the printed material 150 while having reflective intensity information in accordance with the printed pattern (such as letters and figures) as shown by the arrows F.

Here, if the light reflected by the printed material 150 is diffused, unnecessary information enters the light receiving elements 13 and the resolution of the read image, which will be described later, will be deteriorated, but in the present embodiment, the lens member 30 prevents the diffusion of the reflected light. That is, as for the reflected light that has been reflected by a surface of the printed material 150, light in oblique directions is blocked (louver function) by the colored sections 32 of the lens member 30, and is collected in the vertical direction (lens function) due to the shape of the transparent sections 31, and then is emitted from the lens member 30 as shown by the arrows G. This makes it possible to prevent reflected light from being mixed together.

The emitted light passes through the protective plate 20 again and is received by the light receiving elements 13 of the liquid crystal display panel 10, and as a result, the image data is read. Because light received at the light receiving elements 13 does not contain reflected light that are mixed together as described above, the read image becomes a read image 250 having high resolution and sharp outlines as shown in FIG. 12, for example.

As described above, in the present embodiment, the lens member 30 is provided between the printed material 150 and the liquid crystal display panel 10 so that the unnecessary diffusion of light reflected by the printed material 150 can be suppressed and the reflected light can enter the light receiving elements 13 of the liquid crystal display panel 10 without being mixed together, thereby suppressing deterioration in resolution of the read image.

Meanwhile, when an image is displayed, as shown in FIG. 13, light emitted from the backlight 40 travels in the vertical direction as shown by the arrows H and is refracted in all oblique directions as shown by the arrows I due to the lens function of the lens member 30. This makes it possible to obtain a wide viewing angle and to realize good image display.

The liquid crystal display device 100 having the above-mentioned configuration is manufactured in the following manner, for example. The method for manufacturing the liquid crystal display panel 10 will be described first. The TFT array substrate 11 of the liquid crystal display panel 10 is formed by forming a base coating film on a principal surface of a cleaned glass substrate, and then forming various wires such as gate signal lines, TFTs and the like. The light receiving element 13 is also formed in each of the pixels at the same time as and by the same process as the TFT formation. This substrate is covered by a gate insulating film, and then a drain electrode is formed. After that, the principal surface of the substrate is covered by an interlayer insulating film, and contact holes are formed in the interlayer insulating film.

A conductive film is formed so as to cover the principal surface of the substrate having the above-mentioned configuration by a method such as sputtering or the like. The conductive film is made of a conductive material with high light transmittance such as Indium Tin Oxide (ITO), Indium Zinc Oxide (IZO), zinc oxide or the like. Next, a resist film is formed so as to cover the obtained conductive film, and exposure/development is performed to create a resist pattern in a desired shape.

The conductive film is etched through the obtained resist pattern to form a pixel electrode. The etching process may be either a dry-etching process or a wet-etching process.

Meanwhile, the CF substrate 12 is obtained by forming a color filter layer (not shown in the figures) on the principal surface of the glass substrate, by covering the color filter layer with an insulating layer (not shown in the figures), and then by forming an opposite electrode made of ITO by sputtering or the like.

The TFT array substrate 11 and the CF substrate 12 that have been manufactured as described above are attached to each other through a sealing material (encapsulating material), and liquid crystal is sealed between the substrates. The sealing material is not specially limited, and ultraviolet-curable resin, heat-curable resin or the like may be used. Then, the glass substrates are provided with the polarizing plates 14 and 15 on the sides opposite to the sides facing the liquid crystal layer, and as a result, the liquid crystal display panel 10 is obtained.

The obtained liquid crystal display panel 10 is provided with the backlight 40 on the side opposite to the display surface side. Moreover, the protective plate 20 is formed on the display side of the liquid crystal display panel 10, and the lens member 30 is further disposed there. As a result, the liquid crystal display device 100 of the present embodiment is obtained.

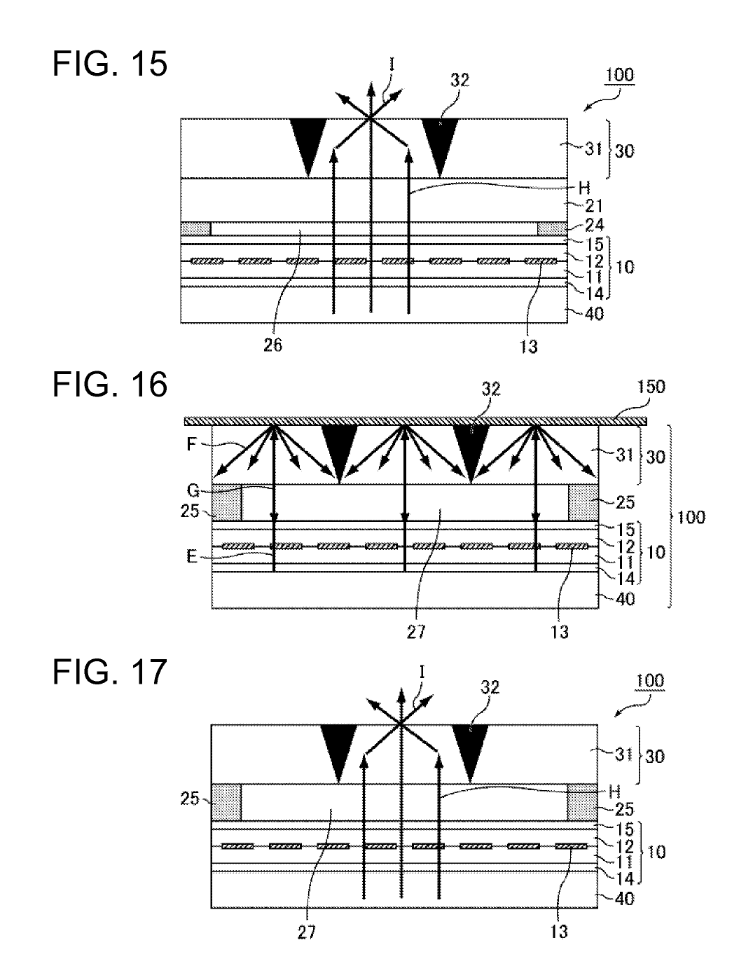

The configuration in which the protective plate 20 and the liquid crystal display panel 10 are fully attached to each other was introduced as an example in the above-mentioned description, but the present invention is not limited to such, and the effects similar to that of the above-mentioned configuration can be obtained when using a configuration in which the protective plate 21 and the liquid crystal display panel 10 are attached to each other through spacers 24 so that an air layer 26 is formed therebetween as shown in FIGS. 14 and 15.

Moreover, the effects similar to the above-mentioned configurations can be obtained even when the protective plate 20 is removed, and the lens member 30 and the liquid crystal display panel 10 are attached to each other through spacers 25 so that an air layer 27 is formed between the lens member 30 and the liquid crystal display panel 10 as shown in FIGS. 16 and 17.

### Embodiment 2

In the present embodiment, a liquid crystal display device configured such that a lens member thereof is detachably installed on the liquid crystal display panel will be described. Here, the same reference characters are used for the components similar to the above-mentioned Embodiment 1, and the description of them will be omitted.

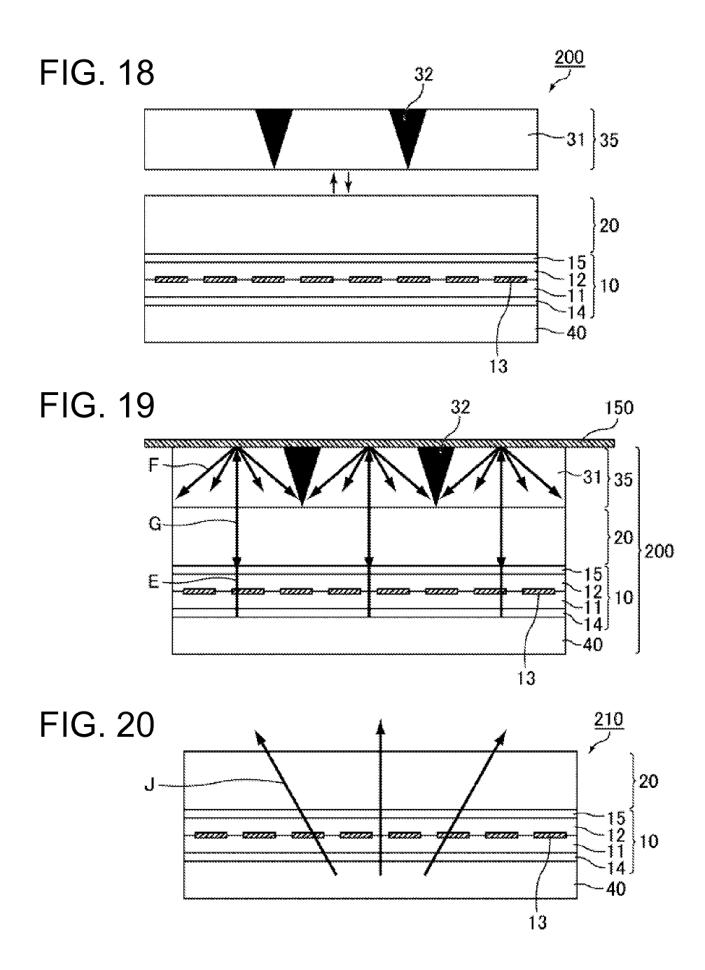

FIG. 18 is a schematic longitudinal cross-sectional view showing the configuration of a liquid crystal display device according to the present embodiment. In FIG. 18, a liquid crystal display device 200 is configured such that a lens member 35 is detachably configured, and the device is used with the lens member 35 attached to the liquid crystal display panel 10 when scanning, and is used with the lens member 35 detached from the liquid crystal display panel 10 when an image is being displayed. The basic configuration of the lens member 35 is similar to the lens member 30 according to the above-mentioned Embodiment 1.

FIG. 19 is a schematic cross-sectional view showing the configuration of the liquid crystal display device 200 when scanning, and FIG. 20 is a schematic cross-sectional view showing the configuration of the liquid crystal display device 200 when an image is being displayed. As shown in FIG. 19, the lens member 35 is attached when scanning, and image data is read in a manner similar to the above-mentioned Embodiment 1.

In the present embodiment, when an image is being displayed, as shown in FIG. 20, the lens member 35 is detached so that there is no structure except for the protective plate 20 existing on a display surface of the liquid crystal display panel 10. As a result, light is emitted from the liquid crystal display panel 10 in a manner shown by the arrows J, and wide viewing angle characteristics can be achieved.

Further, similarly to the above-mentioned Embodiment 1, the liquid crystal display device 200 of the present embodiment can also have a configuration in which the protective plate 20 is absent, or a configuration in which an air layer is provided between the protective plate 20 and the liquid crystal display panel 10.

### Embodiment 3

In the present embodiment, a liquid crystal display device using a glass fiber array as its protective member will be described.

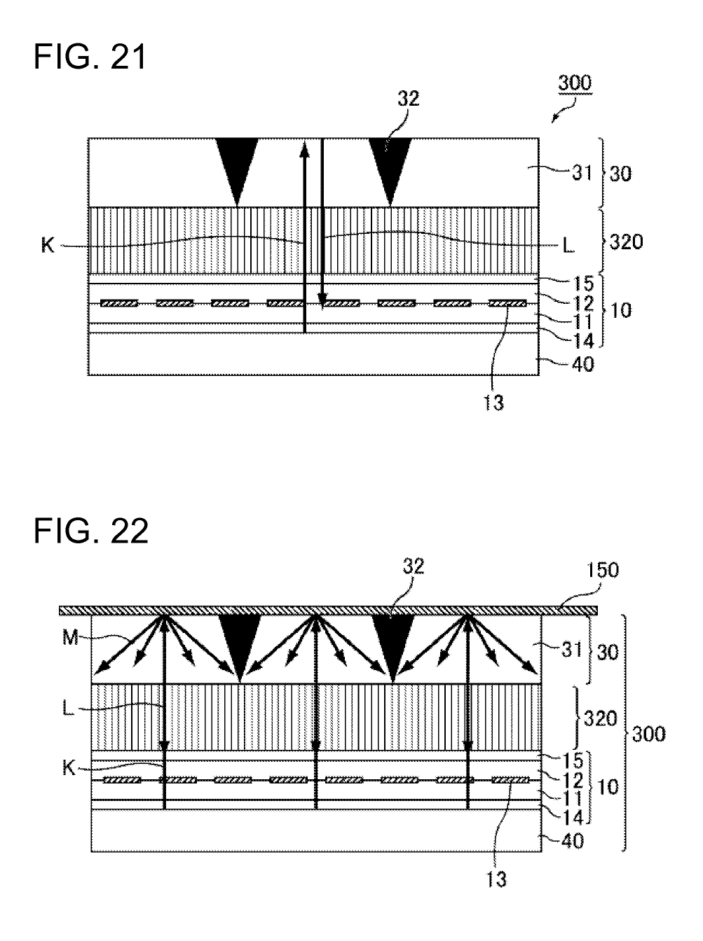

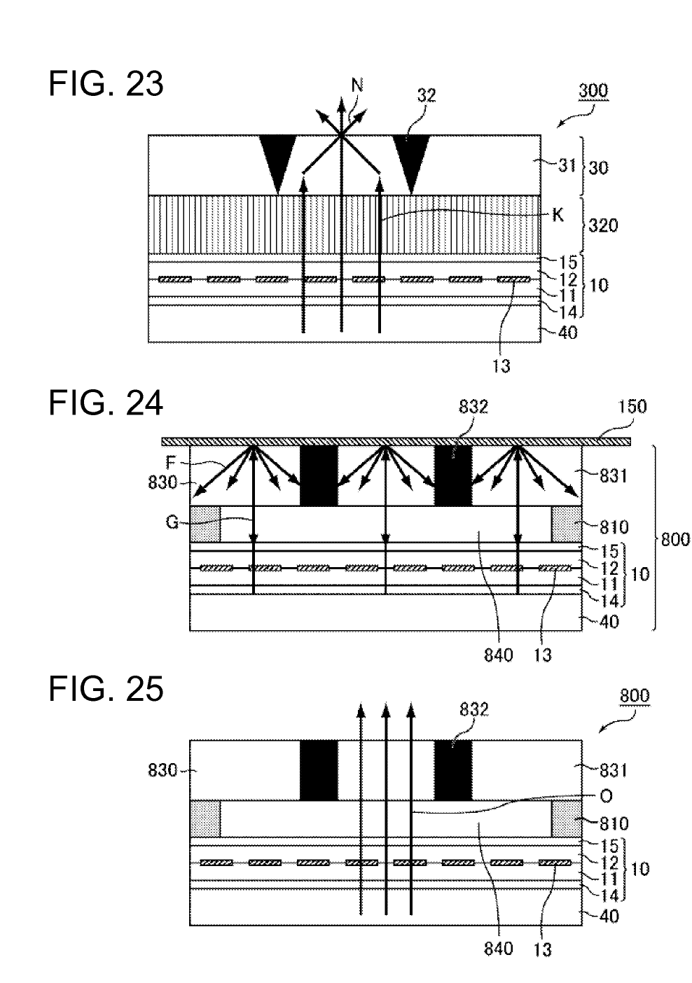

FIG. 21 is a schematic longitudinal cross-sectional view showing the configuration of a liquid crystal display device according to the present embodiment, and FIG. 22 is a schematic longitudinal cross-sectional view showing the liquid crystal display device of the present embodiment when scanning, and FIG. 23 shows the same when an image is being displayed.

In FIG. 21, the glass fiber array 320 includes a plurality of glass fibers that are bundled so as to be perpendicular to a panel surface of the liquid crystal display panel 10. Because a glass fiber array 320 is provided between the lens member 30 and the liquid crystal display panel 10, light emitted from the backlight 40 is guided vertically in the upward direction as shown by the arrow K, and light reflected by a printed material (not shown in FIG. 21) is guided vertically in the downward direction as shown by the arrow L.

In a liquid crystal display device 300 according to the present embodiment, when scanning, light from the backlight 40 perpendicularly enters the glass fiber array 320 as shown by the arrows K and illuminates the printed material 150 as shown in FIG. 22. Reflected light generated at the printed material 150 is diffused at the transparent sections 31 as shown by the arrows M, but because of the louver function and the lens function of the lens member 30, the light is guided to the glass fiber array 320 and enters the liquid crystal display panel 10 as vertical light as shown by the arrows L. Thus, the reflected light generated at the printed material 150 enters the light receiving elements 13 without being mixed together because of the louver function of the lens member 30 and the light guiding function of the glass fiber array 320, and therefore, deterioration in resolution can be suppressed. Here, the thickness of the glass fiber array 320 has little impact on the resolution.

When an image is being displayed, as shown in FIG. 23, light from the backlight 40 perpendicularly enters the glass fiber array 320 as shown by the arrows K and is emitted to outside after being collected as shown by the arrows N due to the lens function of the lens member 30. As a result, the liquid crystal display device 300 with superior viewing angle characteristics can be achieved.

### COMPARISON EXAMPLE 1

In the present comparison example, a member having only the louver function is used in place of the lens member 30. FIGS. 24 and 25 show the configuration of a liquid crystal display device according to the present comparison example, and FIG. 24 is a schematic longitudinal cross-sectional view showing the liquid crystal display device of the present comparison example when scanning, and FIG. 25 shows the same when an image is being displayed.

As shown in FIGS. 24 and 25, a member having only the louver function 830 has a configuration in which rectangular transparent sections 831 and colored sections 832 are arranged alternatively when seen in plan view.

When scanning, as shown in FIG. 24, light emitted in the direction of the arrows G is diffused at a surface of the printed material 150 in the directions of the arrows F, and therefore, the effects similar to that of the above-mentioned respective embodiments can be obtained. On the other hand, when an image is being displayed, as shown in FIG. 25, light from the backlight 40 is emitted in only one direction as shown by the arrows O, and therefore, a viewing angle becomes narrow and the displayed image becomes blurred when seen in oblique directions.

As described above, when a liquid crystal display device 800 equipped with the member having only the louver function 830 is used, the lens function similar to that of the lens members 30 and 35 of the liquid crystal display devices of the present invention cannot be obtained, and wide viewing angle characteristics cannot be achieved.

### COMPARISON EXAMPLE 2

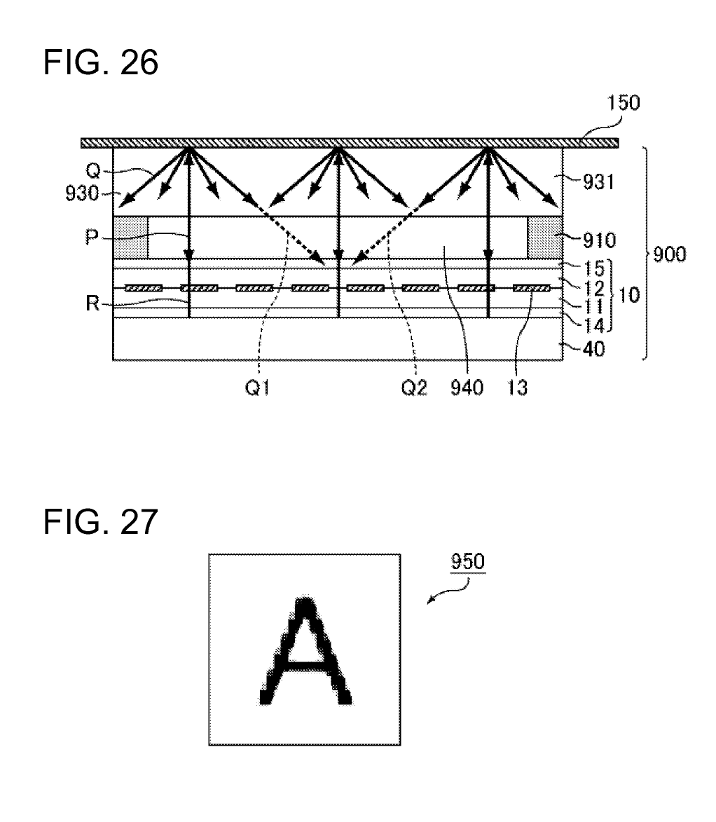

In the present comparison example, a liquid crystal display device that includes neither the lens member 30 nor the member having only the louver function 830 will be described. FIGS. 26 and 27 show the configuration of a liquid crystal display device according to the present comparison example, and FIG. 26 is a schematic longitudinal cross-sectional view showing the liquid crystal display device of the present comparison example when scanning, and FIG. 27 is a plan view showing the obtained image display.

In FIG. 26, the liquid crystal display panel 10, which includes the backlight 40, and a protective plate 930 are attached to each other through spacers 910 in a liquid crystal display device 900. An air layer 940 is formed between the liquid crystal display panel 10 and the protective plate 930.

In the liquid crystal display device 900 having such a configuration, when scanning, as shown in FIG. 26, light emitted in the direction of the arrows P is reflected by a surface of the printed material 150, and a part of the reflected light perpendicularly enters the light receiving elements 13 as shown by the arrows R. However, diffused (scattered) light shown by the arrows Q becomes mixed together and then received by the light receiving elements 13 as shown by the arrows with dotted arrowed lines Q1 and Q2, for example. As a result, as shown in FIG. 27, the obtained read image 950 has low resolution and becomes a blurred image.

A transmissive liquid crystal display device was described as an example of a display device in each of the above-mentioned embodiments, but the present invention is not limited to such, and it may also apply to a transflective liquid crystal display device.

Moreover, a liquid crystal display device was described as an example of a display device in each of the above-mentioned embodiments, but the present invention is not limited to such, and it may also apply to an organic EL display device, an active inorganic EL display device, or the like. In this case, the effects similar to each of the above-mentioned embodiments can be achieved by using an organic EL panel or an inorganic EL panel in place of a liquid crystal display panel. However, an organic EL panel or an inorganic EL panel are self-luminous display panels, and therefore, a light source such as a backlight is not necessary.

The respective configurations of the above-described embodiments may be combined as appropriate without departing from the scope of the present invention.

The present application claims priority to Patent Application No. 2009-231567 filed in Japan on Oct. 5, 2009 under the Paris Convention and provisions of national law in a designated State. The entire contents of which are hereby incorporated by reference.

### DESCRIPTION OF REFERENCE CHARACTERS

10 Liquid crystal display panel

11, 12 Substrates

13 Light receiving element

14, 15 Polarizing plates

20, 21, 930 Protective plates

24, 25, 910 Spacers

26, 27 Air layers

30, 30a, 30b , 35 Lens members

31, 31a, 31b, 31c, 831 Transparent sections

32, 32a, 32b, 32c, 832 Colored sections

33a First lens member

33b Second lens member

40 Backlight

100, 200, 300, 800, 900 Liquid crystal display devices

150 Printed material

250, 950 Read image

320 Glass fiber array

830 Member having only the louver function

1. A display device equipped with a display panel for reading and displaying an image data,
wherein said display panel comprises a plurality of pixels having light receiving elements,
wherein a plate-shaped lens member is arranged on a display surface side of said display panel, and
wherein said lens member has a configuration in which a transparent section made of a material with high refractive index and a colored section made of a material with low refractive index are arranged alternatively when viewed in a plan view, and in a cross-section in thickness direction, said transparent section has a trapezoidal shape that is wider on a display panel side, and said colored section has a shape that is narrower on the display panel side.

2. The display device according to claim 1, wherein said display device further includes a protective member between said display panel and said lens member.

3. The display device according to claim 1, wherein said display device further includes an air layer between said display panel and said lens member.

4. A display device according to claim 1, wherein said lens member is detachably configured on said display panel, and said lens member is attached to said display panel when an image is read.

5. The display device according to claim 2, wherein said protective member is a glass fiber array including a plurality of glass fibers arranged perpendicularly to a panel surface of said display panel.

6. A display device according to claim 1, wherein said display device is a liquid crystal display device, and further comprises a light source on a side of said display panel that is opposite to a side on which said lens member is disposed.
